(19) United States
(12) Patent Application Publication
(10) Pub. No.: US 2025/0193893 A1
(43) Pub. Date: Jun. 12, 2025

(54) METHOD AND APPARATUS FOR MONITORING DOWNLINK CONTROL CHANNEL IN WIRELESS COMMUNICATION SYSTEM

(71) Applicant: Samsung Electronics Co., Ltd., Suwon-si, Gyeonggi-do (KR)

(72) Inventors: Qi ZHANG, Beijing (CN); Tong SU, Beijing (CN); Feifei SUN, Beijing (CN)

(21) Appl. No.: 18/843,879

(22) PCT Filed: Mar. 6, 2023
(86) PCT No.: PCT/KR2023/003009

§ 371 Date: Sep. 4, 2024

(30) Foreign Application Priority Data
Mar. 4, 2022 (CN) 202210210887.1
Dec. 30, 2022 (CN) 202211732765.5

(51) Int. Cl. H04W 72/23; H04L 5/00

(52) U.S. Cl. CPC H04W 72/23; H04L 5/0005

(57) ABSTRACT

The disclosure relates to a 5G or 6G communication system for supporting a higher data transmission rate. The disclosure discloses a method and a device in a wireless communication system. According to an embodiment of the present disclosure, there is provided a method performed by a terminal in a wireless communication system, comprising: receiving, a frequency domain configuration of a control resource set (CORESET), determining a frequency domain area where a control resource set (CORESET) is located, wherein the frequency domain area where the CORESET is located comprises at least a part of the frequency domain area of CORESET determined based on the received frequency domain configuration of the CORESET; and monitoring a physical downlink control channel (PDCCH) based on the determined frequency domain area where the CORESET is located.

### TECHNICAL FIELD

The present application relates to the field of wireless communication technology, and particularly, a method and a device including a user equipment and a network side device in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

According to an aspect of the present disclosure, there is provided a method performed by a terminal in a wireless communication system, comprising: receiving, a frequency domain configuration of a control resource set (CORESET), determining a frequency domain area where the CORESET is located, wherein the frequency domain area where the CORESET is located includes at least a part of the frequency domain area of CORESET determined based on the received frequency domain configuration of the CORESET; and monitoring a physical downlink control channel PDCCH based on the determined frequency domain area where the CORESET is located.

### Advantageous Effects of Invention

According to embodiments of the disclosure, a service may be effectively provided in a wireless communication system.

### BRIEF DESCRIPTION OF DRAWINGS

FIG. 1 is an overall structure of a wireless network;

FIGS. 2A and 2B are a transmission path and a reception path;

FIGS. 3A and 3B are structural diagrams of a UE and a base station, respectively;

FIG. 4 illustrates a schematic structural diagram of a synchronization signal/physical broadcast channel block (SSB or SS/PBCH block);

FIG. 5 illustrates a schematic diagram of CCE when part of RB is added;

FIGS. 6 to 12 illustrate part of frequency domain configuration of the CORESET, according to an embodiment of the present disclosure;

FIG. 13 illustrates a schematic diagram of a terminal receiving a CORESET frequency domain indication that an RB group is not fully contained in the BWP, according to an embodiment of the present disclosure;

FIG. 14 illustrates a schematic diagram of a terminal receiving a CORESET frequency domain indication of a predefined granularity, according to an embodiment of the present disclosure;

FIG. 15 illustrates a schematic diagram of a terminal determining an effective frequency domain configuration of the CORESET, according to an embodiment of the present disclosure;

FIG. 16 illustrates a schematic diagram of a mapping of PDCCH candidates to CCE;

FIG. 17 illustrates a schematic diagram of a terminal determining an effective frequency domain configuration of the CORESET, according to another embodiment of the present disclosure;

FIG. 18 illustrates a schematic diagram of a terminal receiving PDCCH candidates of different aggregation levels;

FIG. 19 shows a schematic diagram of a method, according to an embodiment of the present disclosure; and

FIGS. 20 to 39 show schematic diagrams that the terminal device determines aggregation level in the CORRESET0 according to various embodiments of the present disclosure.

FIG. 40 is a block diagram of a configuration of a base station, according to an embodiment of the disclosure; and

FIG. 41 is a block diagram showing a structure of a terminal, according to an embodiment of the disclosure.

### BEST MODE FOR CARRYING OUT THE INVENTION

According to an aspect of the present disclosure, there is provided a method performed by a terminal in a wireless communication system, comprising: receiving, a frequency domain configuration of a control resource set (CORESET), determining a frequency domain area where the CORESET is located, wherein the frequency domain area where the CORESET is located includes at least a part of the frequency domain area of CORESET determined based on the received frequency domain configuration of the CORESET; and monitoring a physical downlink control channel PDCCH based on the determined frequency domain area where the CORESET is located.

In one embodiment, the frequency domain configuration of the CORESET includes one or more resource block (RB) groups, wherein at least one RB in one RB group of the one or more RB groups is within the BWP bandwidth.

In various embodiments, the method further comprises: receiving a time domain duration of the CORESET corresponding to the frequency domain configuration of the CORESET, wherein, when the number of RBs in the BWP bandwidth of the one RB group in the frequency domain configuration of the CORESET is 1, the time domain duration is 6; and/or when the number of RBs in the BWP bandwidth of the one RB group in the frequency domain configuration of the CORESET is 2, the time domain duration is 3 or 6; and/or when the number of RBs in the BWP bandwidth of the one RB group in the frequency domain configuration of the CORESET is 3, the time domain duration is 2 or 6; and/or when the number of RBs in the BWP bandwidth of the one RB group in the frequency domain configuration of the CORESET is 4 or 5, the time domain duration is 6.

In one embodiment, the number of RBs included in the resource block (RB) group is a predefined value.

In one embodiment, the predefined value is a positive integer less than 6.

In one embodiment, the method further comprises receiving the time domain duration of CORESET corresponding to the frequency domain configuration of the CORESET, wherein the product of the time domain duration and the number of RBs occupied by all RB groups in the frequency domain configuration of the CORESET is a multiple of 6.

In one embodiment, the method further comprises receiving the time domain duration of the CORESET, interleaving configuration and resource element group (REG) bundle configuration corresponding to the frequency domain configuration of the CORESET, wherein when the time domain duration is 6 and the interleaving configuration is interleaving, the size of the resource element group (REG) bundle is 6.

In one embodiment, at least a part of the frequency domain area of CORESET determined based on the frequency domain configuration of the CORESET includes the bandwidth occupied by a predefined number of RBs starting from a specific RB in a specific RB group in the frequency domain area indicated by the frequency domain configuration of the CORESET.

In one embodiment, the starting point of the frequency domain area of the CORESET is determined by a specific RB in the specific RB group, and wherein the specific RB is an RB with an offset spacing from the first RB in the RB group with the smallest index indicated by the bit being 1 indicated by the frequencyDomainResources configuration parameter.

In one embodiment, the bandwidth occupied by the predefined number of RBs is less than or equal to the channel bandwidth supported by the terminal.

In one embodiment, the offset is indicated by Radio Resource Control (RRC) signaling and/or media access control control element (MAC CE) and/or downlink control information (DCI) signaling; and/or wherein the offset is determined by mapping PDCCH candidates to CCEs and the frequency domain positions of CCEs.

In one embodiment, the method further comprises: monitoring a physical downlink control channel (PDCCH) based on non-interleaved CORESET; and/or wherein the interleaving configuration corresponding to the received frequency domain configuration of the CORESET is non-interleaving.

In one embodiment, the interleaving configuration is used to indicate whether CORESET is interleaved, wherein the interleaving configuration is indicated by a specific field in the physical broadcast channel (PBCH).

In one embodiment, the specific field is a reserved bit in the payload, and wherein the CORESET is CORESET0.

In one embodiment, the method can also include: the determined CORESET0 is associated with the CCE (Control Resource Element)-to-REG (Resource Element Group) mapping, and the CCE to REG mapping is interleaved. The terminal determines the aggregation level in the frequency domain of CORESET0 according to the CCE to REG mapping within the frequency domain of CORESET0 determined; and receives one or more PDCCHs according to the determined aggregation level. The one or more PDCCHs can be used for the physical downlink shared channel (PDSCH) indication of SIB1 messages.

In a more specific embodiment, for the mapping of CCE to REG:
The determined CORESET0 includes multiple REG bundles. The ith REG bundle includes the {iL, iL+1, iL+L−1}th REG. L is the number of REGs included in a REG bundle. The range of i is 0, 1, . . . , N_{REG}^{CORESET}/L−1, N_{REG}^{CORESET} is the product of N_{RB}^{CORESET} and N_{symb}^{CORESET}, that is, symb the number of REGs (that is, the number of RBs) within the determined time-frequency resource range of CORESET0, N_{symb}^{CORESET} is the number of RBs included in the determined CORESET0, N_{symb}^{CORESET} is the time domain symbol included in the determined CORESET0. When N_{RB}^{CORESET} is 15, the value of L can be 3, 5 or 6. When N_{RB}^{CORESET} is 16, the value of L can be 2, 4, 6 or 8.
The jth CCE included in the determined CORESET0 includes the {f (Xj/L), f (Xj/L+1), . . . , f (Xj/L+X/L−1)}th REG bundle. The value of X can be specified in the protocol, notified by the network equipment through high-level signaling, predefined by the system, or equal to the value of L.

Among them,

$$f ( x ) = ( r C + c + {n}_{shift} ) mod ( {N}_{R E G}^{C O R E S E T} / L ) \\ x = c R + r \\ r = 0 , 1 , … , R - 1 \\ c = 0 , 1 , … , C - 1 \\ C = {N}_{R E G}^{C O R E S E T} / ( LR )$$

Where R is a preconfigured parameter. When N_{RB}^{CORESET} is 15, the value of R can be 2, 3, 4, 5 or 8. When N_{RB}^{CORESET} is 16, the value of R can be 2 or 4.

n_{shift} refers to the ID of the cell after the terminal equipment accesses, or the ID of the cell receiving downlink control channel/data channel.

In various embodiments, when N_{REG}^{CORESET}/(LR) is not an integer, that is, C is not an integer, then C is rounded up, that is, the value of C is the smallest integer greater than itself.

In one embodiment, when N_{symb}^{CORESET} equals 1, N_{RB}^{CORESET} equals 15, L equals 3 and R equals 2, or L equals 3 and R equals 3. At this time, the value of X is 3.

In one embodiment, when N_{symb}^{CORESET} equals 2, N_{RB}^{CORESET} equals 15, L equals 6 and R equals 2, or L equals 6 and R equals 3. At this time, the value of X is 6.

In one embodiment, when N_{symb}^{CORESET} equals 2, N_{RB}^{CORESET} equals 15, L equals 3 and R equals 2, or L equals 3 and R equals 5. At this time, the value of X is 3.

In one embodiment, when N_{symb}^{CORESET} equals 3, N_{RB}^{CORESET} equals 15, L equals 5 and R equals 2, or L equals 5 and R equals 5. At this time, the value of X is 5.

In one embodiment, when N_{symb}^{CORESET} equals 3, N_{RB}^{CORESET} equals 15, L equals 3 and R equals 2, or L equals 3 and R equals 4, or L equals 3 and R equals 8. At this time, the value of X is 3.

In one embodiment, when N_{symb}^{CORESET} equals 1, N_{RB}^{CORESET} equals 16, L equals 4 and R symb equals 2, and the value of X is 4.

In one embodiment, when N_{symb}^{CORESET} equals 2, N_{RB}^{CORESET} is equal to 16, X is 4, L is 4 and R is 2, or L equals 4 and R equals 4.

In one embodiment, when N_{symb}^{CORESET} equals 3, N_{RB}^{CORESET} is equal to 16, the value of X is 6. L equals 6 and R equals 2; or L equals 6 and R equals 4.

In one embodiment, when N_{symb}^{CORESET} equals 4, N_{RB}^{CORESET} is equal to 16, the value of X is 4. L equals 4 and R equals 2; or L equals 4 and R equals 4.

In one embodiment, when N_{symb}^{CORESET} equals 4, N_{RB}^{CORESET} is queal to 16, X is 8, L equals 8 and R equals 2; or L equals 8 and R equals 4.

In one embodiment, the aggregation level(s) of the Type0/0A/2-PDCCH common search space (CSS) corresponding to the received frequency domain configuration of the CORESET is 1 or 2 or 4 or 8 or 16.

According to another aspect of the present disclosure, there is provided a terminal in a wireless communication system, which includes a transceiver configured to transmit and receive signals; and a processor coupled to the transceiver and configured to control the transceiver to perform the methods described in the above embodiments.

According to another aspect of the present disclosure, there is provided a method performed by a base station in a wireless communication system, which includes transmitting a frequency domain configuration of a control resource set (CORESET) to a terminal, and transmitting a physical downlink control channel (PDCCH) to the terminal, wherein the frequency domain area where the PDCCH is located is at least a part of the frequency domain area determined by the frequency domain configuration of the CORESET.

In one embodiment, the frequency domain configuration of the CORESET includes one or more resource block (RB) groups, wherein a part of RBs in one RB group of the one or more RB groups is within the BWP bandwidth.

In one embodiment, the method further comprises: transmitting a time domain duration of the CORESET corresponding to the frequency domain configuration of the CORESET to the terminal, wherein when the number of RBs in the BWP bandwidth of one RB group in the frequency domain configuration of the CORESET is 1, the time domain duration is 6; and/or when the number of RBs in the BWP bandwidth of one RB group in frequency domain configuration of the CORESET is 2, the time domain duration is 3 or 6; and/or when the number of RBs in the BWP bandwidth of one RB group in the frequency domain configuration of the CORESET is 3, the time domain duration is 2 or 6; and/or when the number of RBs in the BWP bandwidth of one RB group in frequency domain configuration of the CORESET is 4 or 5, the time domain duration is 6.

In one embodiment, the number of RBs included in the resource block (RB) group is a predefined value.

In one embodiment, the predefined value is a positive integer less than 6.

In one embodiment, the method further comprises transmitting a time domain duration of CORESET corresponding to the frequency domain configuration of the CORESET, wherein the product of the time domain duration and the number of RBs occupied by all RB groups in the frequency domain configuration of the CORESET is a multiple of 6.

In one embodiment, the method further comprises transmitting a time domain duration of the CORESET, an interleaving configuration and a resource element group (REG) bundle configuration corresponding to the frequency domain configuration of the CORESET, wherein when the time domain duration is 6 and the interleaving configuration is interleaving, the size of the resource element group (REG) bundle is 6.

In one embodiment, at least a part of the frequency domain area where the PDCCH is located includes the bandwidth occupied by a predefined number of RBs starting from a specific RB in a specific RB group in the frequency domain area indicated by the frequency domain configuration of the CORESET.

In one embodiment, the starting point of the frequency domain area of the CORESET is determined by a specific RB in the specific RB group, and wherein the specific RB is an RB with an offset spacing from the first RB in the RB group with the smallest index indicated by the bit being 1 indicated by the frequencyDomainResources configuration parameter.

In one embodiment, the bandwidth occupied by the predefined number of RBs is less than or equal to the channel bandwidth supported by the terminal.

In one embodiment, the offset is indicated by RRC signaling and/or media access control control element (MAC CE) and/or downlink control information (DCI) signaling; and/or wherein the offset is determined by mapping PDCCH candidates to CCEs and the frequency domain positions of CCEs.

In one embodiment, the interleaving configuration corresponding to the transmitted frequency domain configuration of the CORESET is non-interleaved and/or the physical downlink control channel PDCCH is transmitted based on the non-interleaved CORESET.

In one embodiment, the interleaving configuration is used to indicate whether CORESET is interleaved, wherein the interleaving configuration is indicated by a specific field in the physical broadcast channel (PBCH).

In one embodiment, the specific field is a reserved bit in the payload, and wherein the CORESET is CORESET0.

In one embodiment, the aggregation level(s) of the Type0/0A/2-PDCCH common search space (CSS) corresponding to the transmitted frequency domain configuration of the CORESET is 1 or 2 or 4 or 8 or 16.

According to another aspect of the present disclosure, there is provided a base station in a wireless communication system, including a transceiver configured to transmit and receive signals; and a processor configured to control the transceiver to perform the methods described in the above embodiments.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skilled in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In order to make the purposes, technical solutions and advantages of the embodiments of the present disclosure clearer, the technical solutions of the embodiments of the present disclosure will be clearly and completely described below with reference to the drawings of the embodiments of the present disclosure. Obviously, the described embodiments are part of the embodiments of this disclosure, but not all of them. Based on the described embodiments of this disclosure, all other embodiments obtained by ordinary skilled in the art without inventive labor are within the scope of protection of this disclosure. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Before the following description of the specific embodiments, it may be beneficial to clarify the definitions of some words and phrases used throughout this patent document. The term “coupling” and its derivatives refer to any direct or indirect communication between two or more elements, whether or not these elements are in physical contact with each other. The terms “transmitting”, “receiving” and “communicating” and their derivatives contain both direct and indirect communication. The terms “comprising” and “including” and their derivatives mean including but not limited to. The term “or” is inclusive, meaning and/or. The phrase “associated with” and its derivatives mean comprising, comprised in, connected to, interconnected with, including, included in, connected to or connected with, coupled to or coupled with, able to communicate with, collaborate with, interweave, juxtapose, approach and bound to or bound with, have, have the property of, have a relationship with or have a relationship with, etc. The term “controller” means any device, system or part thereof that controls at least one operation. Such a controller can be implemented in hardware or a combination of hardware and software and/or firmware. The functions associated with any particular controller can be centralized or distributed locally or remotely. The phrase “at least one of . . . ” when used with a list of items means that different combinations of one or more listed items can be used, and only one item in the list may be needed. For example, “at least one of A, B and C” includes any of the following combinations: A, B, C, A and B, A and C, B and C, and A and B and C. For example, “at least one of A, B or C” includes any of the following combinations: A, B, C, A and B, A and C, B and C, and A and B and C.

In addition, various functions described below can be implemented or supported by one or more computer programs, each of which is formed by computer readable program code and embodied in a computer readable medium. The terms “application” and “program” refer to one or more computer programs, software components, instruction sets, processes, functions, objects, classes, instances, related data or parts thereof suitable for implementation in suitable computer readable program code. The phrase “computer readable program code” includes any type of computer code, including source code, object code and executable code. The phrase “computer readable medium” includes any type of medium that can be accessed by a computer, such as Read-Only Memory (ROM), Random Access Memory (RAM), hard disk drive, compact disk (CD), digital video disk (DVD) or any other type of memory. “Non-transitory” computer-readable media excludes wired, wireless, optical or other communication links that transmit transient electrical signals or other signals. Non-transitory computer-readable media include media that can permanently store data and media that can store and rewrite data later, such as rewritable optical disks or erasable memory devices.

Terms used here to describe embodiments of the present invention are not intended to limit and/or define the scope of the present invention. For example, unless otherwise defined, the technical terms or scientific terms used in this disclosure should have the ordinary meanings understood by those with ordinary skills in the art to which this invention belongs.

It should be understood that “first”, “second” and similar words used in this disclosure do not indicate any order, quantity or importance, but are only used to distinguish different components. Unless the context clearly indicates otherwise, singular words such as “a”, “an” or “the” also do not indicate the quantity limitation, but the existence of at least one.

As used herein, any reference to “one example” or “an example”, “one embodiment” or “an embodiment” means that a specific element, feature, structure or characteristic described in connection with the embodiment is included in at least one embodiment. The phrases “in one embodiment” or “in one example” appearing in different places in the specification do not necessarily all refer to the same embodiment.

As used herein, “a part” of a certain thing means “at least some” of it, so it may mean less than all of it or all of it. Therefore, “a part” of a thing includes the whole thing as a special case, that is, an example in which the whole thing is a part of a thing.

As used herein, the term “set” means one or more. Therefore, the set of items can be a single item or a set of two or more items.

In this disclosure, expressions such as “greater than” or “less than” are used as examples in order to determine whether certain conditions are met, and expressions such as “greater than or equal to” or “less than or equal to” are also applicable and not excluded. For example, the condition defined by “greater than or equal to” can be replaced by “greater than” (or vice versa), the condition defined by “less than or equal to” can be replaced by “less than” (or vice versa), and so on.

It will be further understood that similar words such as the term “including” or “including” mean that the elements or objects appearing before the word cover the listed elements or objects appearing after the word and their equivalents, without excluding other elements or objects. Words like “connected” or “interconnected” are not limited to physical or mechanical connections, but can include electrical connections, whether direct or indirect. “Up”, “down”, “left” and “right” are only used to indicate the relative positional relationship. When the absolute position of the described object changes, the relative positional relationship may also change accordingly.

The various embodiments discussed below for describing the principles of the present disclosure in this patent document are for illustration only, and should not be construed as limiting the scope of the present disclosure in any way. Those skilled in the art will understand that the principles of the present disclosure can be implemented in any suitably arranged wireless communication system. For example, although the following detailed description of the embodiments of the present disclosure will focus on LTE and 5G communication systems, those skilled in the art can understand that the main points of the present disclosure can also be applied to other communication systems with similar technical backgrounds and channel formats with slight modifications without substantially departing from the scope of the present disclosure.

The following description with reference to the drawings is provided to facilitate a comprehensive understanding of various embodiments of the present disclosure defined by the claims and their equivalents. This description includes various specific details to facilitate understanding but should only be considered as exemplary. Therefore, those skilled in the art will recognize that various changes and modifications can be made to the various embodiments described herein without departing from the scope and spirit of the present disclosure. In addition, for the sake of clarity and conciseness, the description of well-known functions and structures may be omitted.

Terms and expressions used in the following specification and claims are not limited to their dictionary meanings, but are only used by the inventors to enable a clear and consistent understanding of the present disclosure. Therefore, it should be obvious to those skilled in the art that the following descriptions of various embodiments of the present disclosure are provided only for the purpose of illustration and not for the purpose of limiting the present disclosure as defined by the appended claims and their equivalents.

It should be understood that singular forms of “a”, “an” and “the” include plural referents, unless the context clearly indicates otherwise. Thus, for example, references to “component surfaces” include references to one or more such surfaces.

The term “including” or “may include” refers to the existence of the corresponding disclosed functions, operations or components that can be used in various embodiments of the present disclosure, rather than limiting the existence of one or more additional functions, operations or features. In addition, the term “comprising” or “having” can be interpreted to indicate certain characteristics, numbers, steps, operations, constituent elements, components or combinations thereof, but should not be interpreted to exclude the possibility of the existence of one or more other characteristics, numbers, steps, operations, constituent elements, components or combinations thereof.

The term “or” used in various embodiments of the present disclosure includes any listed terms and all combinations thereof. For example, “A or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and they should not be interpreted idealized or excessively formally, unless explicitly defined as such in this disclosure.

The technical solution of the embodiments of the present application can be applied to various communication systems, for example, the communication system can include Global System for Mobile Communications (GSM) system, code division multiple access (CDMA) system, Wideband Code Division Multiple Access (WCDMA) system, general packet radio service (GPRS), long term evolution (LTE) system, LTE frequency division duplex (FDD) system, LTE time division duplex (TDD) system, universal mobile telecommunications system (UMTS), worldwide interoperability for microwave access (WiMAX) communication system, 5th generation (5G) system or new radio (NR), etc. In addition, the technical solution of the embodiments of the present application can be applied to future-oriented communication technologies.

Hereinafter, embodiments of the present disclosure will be explained in detail with reference to the accompanying drawings. It should be noted that the same reference numerals in different drawings will be used to refer to the same elements already described.

For the communication problems in the wireless cellular communication scenario, the present disclosure proposes a solution to improve the communication performance in this scenario through the interactive information between the network side entity and the user equipment.

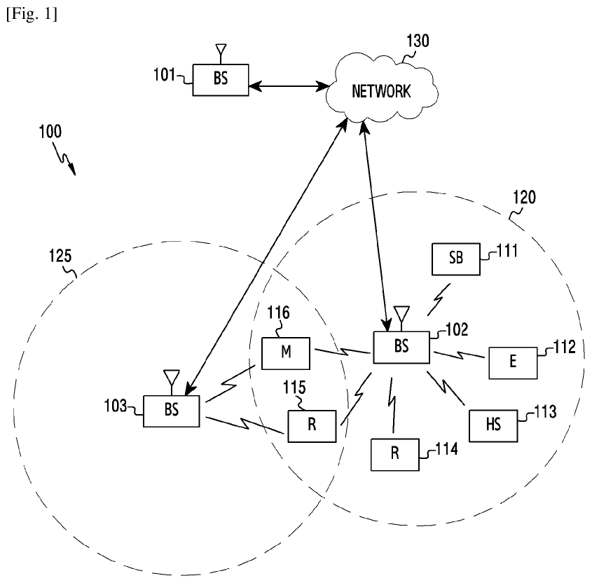

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

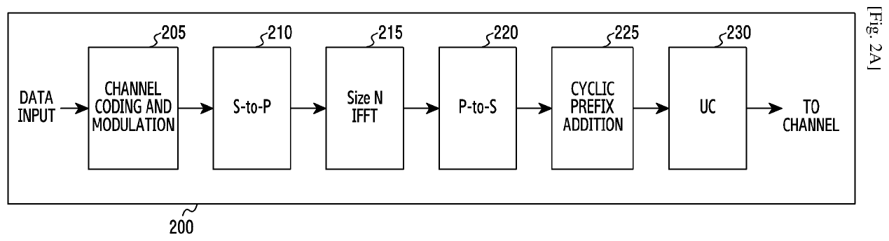

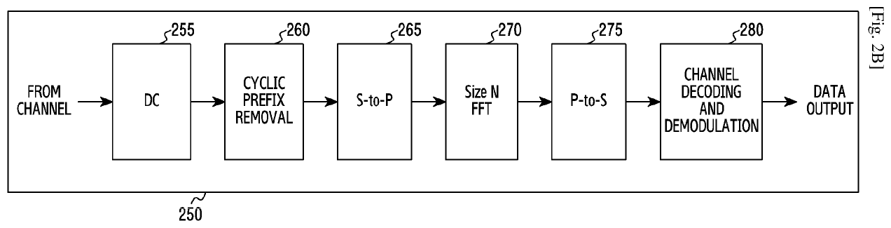

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

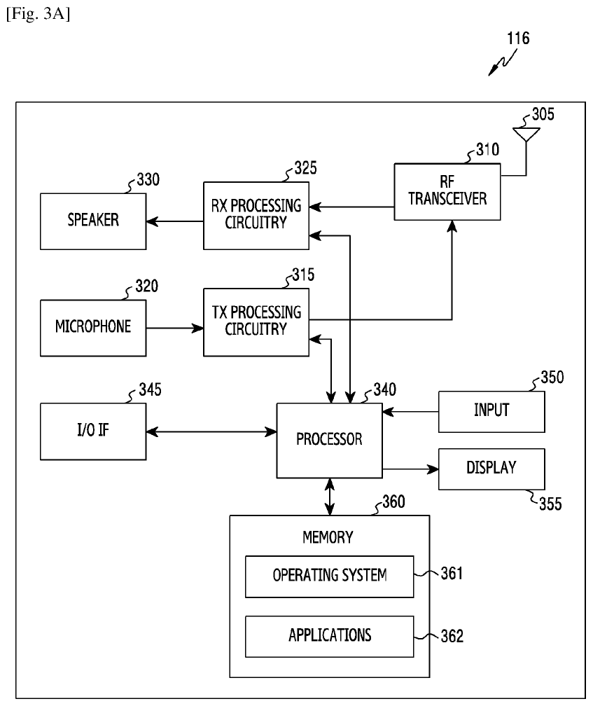

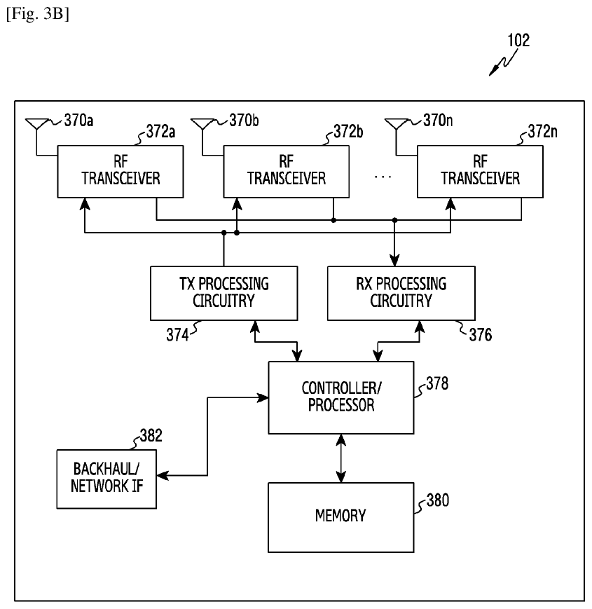

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

UE needs to perform downlink synchronization before initial random access to NR system, receive the necessary configuration of SIB1, and then perform initial random access according to the received SIB1 parameters. NR system designs Primary Synchronization Signals (PSS) and secondary synchronization signals (SSS) for downlink synchronization, and transmits Master Information Block (MIB) in the physical broadcast channel (PBCH).

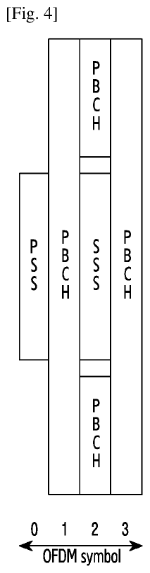

PSS and SSS occupy one symbol and 127 subcarriers in the time domain and frequency domain, and PBCH occupies three symbols and 240 subcarriers in the time domain and frequency domain, as shown in FIG. 4. The synchronization signals PSS, SSS and PBCH channels together constitute SS/PBCH block (SSB).

At present, the Global Synchronization Channel Number (GSCN) supported by the frequency range is specified, which is used for performing downlink synchronization quickly at the frequency range position. The subcarrier in SSB with an index of 120 should be aligned with the synchronization raster.

The 5G (the fifth-generation) system is optimized and designed for enhanced mobile broadband (eMBB), Enhanced Ultra-Reliable Low Latency Communications (eURLLC), Enhanced Machine Type Communication (EMTC), etc.

In order to better support machine communication, 3GPP (The 3rd Generation Partnership Project) defines a simplified UE capability type (for example, reduced capability UE, redcap UE). Compared with other UEs, this type of UE has lower support capability, such as fewer supported antennas, smaller supported bandwidth, etc., so it has lower energy consumption and longer battery life.

The RedCap (reduced capability) terminal has a smaller bandwidth than the eMBB terminal with the lowest requirement of NR, which for example introduces a reduced-capability terminal supporting a maximum bandwidth of 20 MHz in FR1, and it supports BWP (Bandwidth Part) whose configuration is not greater than the bandwidth capability of the terminal. Considering the requirements of application scenarios and other factors, a reduced-capability terminal supporting a maximum bandwidth capability of 5 MHz will be introduced, among which, one requirement for terminal capability is that maximum of its baseband bandwidth capability is 5 MHz, and RF bandwidth can be greater than 5 MHz and not greater than 20 MHz, and the other requirement is that both baseband and RF bandwidth are not greater than 5 MHz. The reduced-capability terminal which supports a maximum bandwidth of 5 MHz can be configured with BWP whose bandwidth not greater than 5 MHz, and also with BWP whose bandwidth is greater than 5 MHz but not greater than 20 MHz. For example, sharing the initial BWP with a 20 MHz reduced-capability terminal for random access ensures that the terminal can receive or transmit signals within the 5 MHz baseband bandwidth through configuration, scheduling and other methods. In addition, for some railway scenes, it needs to support frequency bands (3 MHz to 5 MHz) with a bandwidth less than 5 MHz, such as FRMCS (Future Railway Mobile Communication System), smart utilities, etc. (for example, frequency range RMR-900 band (frequency band), n8, n26, n28), and the minimum channel bandwidth currently supported by these frequency range 16 s is 5 MHz, and the cell with a 3 MHz bandwidth supported by the system will be introduced.

Due to the introduction of terminals or cells with smaller channel bandwidth in the above scenarios, the coverage of control channels (e.g., Physical Downlink Control Channel (PDCCH)) is limited, which will lead to the degradation of the monitoring performance of control channels, thus frequently triggering radio link failures and dete-riorating the system performance. For the above scenarios, the present application proposes a method to monitor the control channel to improve the detection success rate for the physical control channel PDCCH, thereby enhancing the system performance.

In order to increase the spectrum utilization rate of the control channel under a small bandwidth, the present application proposes a method to determine the frequency domain configuration of the control resource set (CORESET).

The system can configure the BWP in its frequency band and CORESET in the BWP frequency band for reduced-capability terminals which support a maximum bandwidth of 5 MHz.

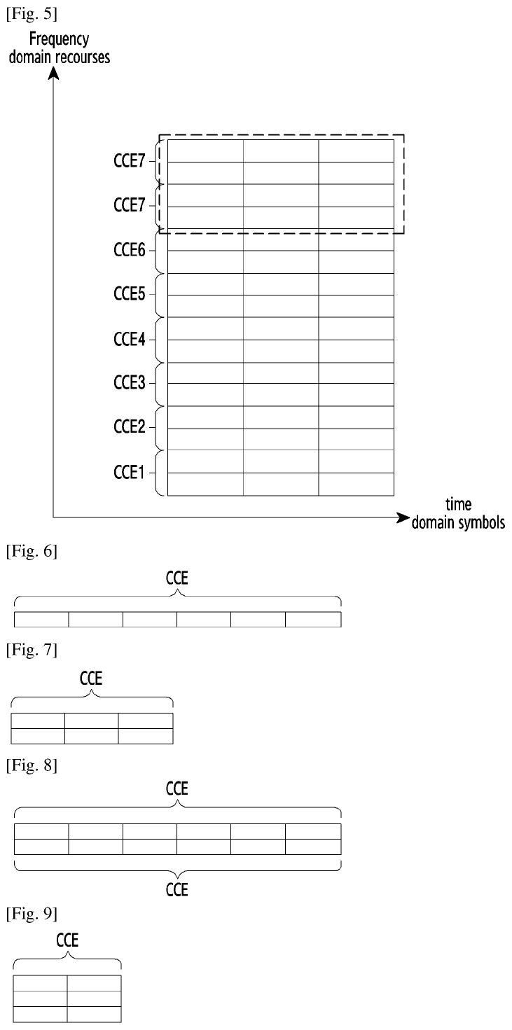

The existing control resource set (CORESET) is configured in the BWP, its frequency domain position is configured with a granularity of a RB group, and each RB group consists of 6 RBs. The mapping from CCE (Control Channel Element) to REG (Resource Element Group) starts from the first OFDM symbol in the CORESET, the RB with the lowest index, and the mapping is carried out in time domain first. When the CORESET has a plurality of symbols, even if the number of REG in frequency domain is not a multiple of 6, CCE can be formed by combining REGs in time domain. For example, as shown in FIG. 5, for a small bandwidth scenario of 3 MHz-5 MHz, assuming that the subcarrier spacing is 15 KHz, the number of RBs is 16, and a maximum number of RBs being 12 can be configured according to the existing CORESET configuration. When the symbol number of the CORESET is 3, the CORESET has 36 REGs, which constitute 6 CCEs. At this time, the maximum aggregation level of PDCCH candidates is 4. However, if 4 RBs are added, that is, 16 RBs are configured, the maximum aggregation level of PDCCH candidates can be 8, and a larger aggregation level facilitates to improve the performance of PDCCH detection by users in the cell edges. As shown in FIG. 5, the dashed box shows the positions of CCEs when 4 RBs are added (assuming there is no interleaving). At the same time, more CCEs can support more PDCCH candidates, and for the cells with smaller bandwidth and terminals with limited bandwidth capability, the frequency domain resources within the frequency band can be utilized to the maximum extent to support more users.

Method 1: a reduced-capability terminal receives frequency domain configuration of the CORESET which does not exceed the bandwidth capability of the terminal.

The bandwidth configured in BWP configuration for the existing reduced-capability terminal should not exceed its maximum supported bandwidth capability. A reduced-capability terminal with a maximum channel bandwidth of 5 MHz is introduced, and its radio frequency capability can be greater than 5 MHz. By restricting baseband scheduling, the channel and signal reception and transmission is within the effective bandwidth of the terminal. A terminal can receive a BWP that does not exceed its maximum supported bandwidth capability, and the CORESET is configured in the BWP.

When the terminal is a reduced-capability terminal supporting a predefined bandwidth, and/or when the bandwidth of the cell where it is located is a predefined value, the configuration of CORESET is determined in a predefined method. In this case, the predefined method includes the following sub-methods.

Sub-Method 1: The Terminal Receiving the CORESET Frequency Domain Indication that the RB Groups are not Fully Contained in the BWP

When the terminal is a reduced-capability terminal and/or the bandwidth of the cell where it is located is a predefined value and/or the RB group, corresponding to the bit indicated by the frequency domain resources parameter frequencyDomainResources in the frequency domain configuration of the CORESET being 1, is not fully contained in the BWP and/or the number of RBs within the BWP bandwidth and the time domain duration of the CORESET configuration in this RB group meet the predefined conditions, then for the RB group, which is not fully contained in the BWP bandwidth, corresponding to the bit indicated by frequencyDomainResources being 1, the RBs in the BWP bandwidth belong to the frequency domain configuration of the CORESET. Otherwise, the terminal determines the frequency domain resources of CORESET according to the indication of frequencyDomainResources, wherein the indication bit of frequencyDomainResources corresponding to the RB group which is not fully contained in the BWP bandwidth is 0. This method can improve the frequency band efficiency.

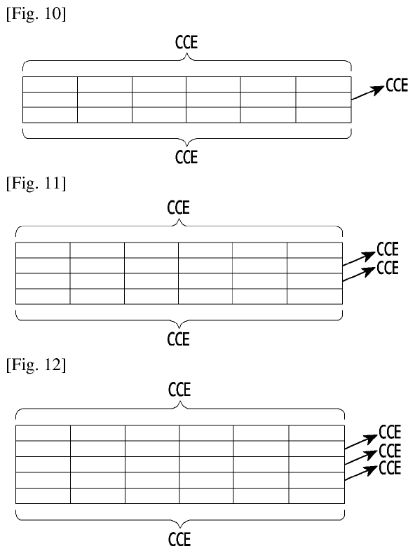

To meet the requirements of CCE-to-REG mapping, the resource block REG composed of time domain and frequency domain of CORESET should be a multiple of 6. Therefore, the CORESET configuration should meet the following predefined conditions: for the RB group, which is not fully contained in the BWP bandwidth, corresponding to the bit indicated by frequencyDomainResources being 1,
when the number of RBs in the BWP bandwidth in the RB group is 1, the duration is 6, as shown in FIG. 6. When interleaving is configured at this time, the REG bundle size is 6
when the number of RBs in the BWP bandwidth in the RB group is 2, the duration is 3 or 6. When the duration is 3, as shown in FIG. 7, when interleaving is configured, the size of a REG bundle is 3 or 6; when the duration is 6, as shown in FIG. 8, the size of the interleaved REG bundle is 6
when the number of RBs in the BWP bandwidth in the RB group is 3, the duration is 2 or 6, as shown in the following figure. When the duration is 2, as shown in FIG. 9, when interleaving is configured, the size of a REG bundle is 2 or 6; when the duration is 6, as shown in FIG. 10, the interleaved REG bundle size is 6
in the RB group, when the number of RBs in the BWP bandwidth is 4 or 5 (as shown in FIG. 11 and FIG. 12, respectively), the duration is 6, as shown in the following figure. At this time, the size of a REG bundle is 6 when interleaving is configured.

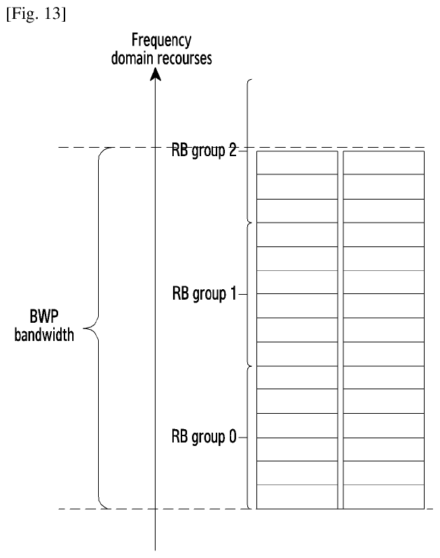

In one embodiment, when a cell bandwidth of 3 MHz to 5 MHz is introduced into the future railway mobile communication system, the terminal first determines whether the newly introduced cell bandwidth is supported or whether the cell bandwidth is 3 MHZ, and then receives a BWP configuration and a CORESET configuration, as shown in FIG. 13, wherein the BWP configuration has 15 RBs, and the CORESET configuration indicates three RB groups with frequencyDomainResources, RB group 2 is a RB group that is not fully contained in the BWP, the first three RBs of that RB group are within the BWP bandwidth and the duration is configured as 2 at this time, therefore, the terminal determines that the frequency domain resources of CORESET are 15 RBs, and this CORESET contains 5 CCEs. In another embodiment, in the above scenario, the duration can also be configured as 6. When the duration is configured as 6, the interleaved REG bundle has a symbol number of 6. The CORESET with more symbols facilitates the enhancement of the performance of downlink control channel in small bandwidth scenarios. According to the CORESET configuration, the terminal performs the mapping of CCEs to REGs, and the mapping of PDCCH candidates to CCEs, and receives PDCCHs.

In one embodiment, the terminal first determines whether it is a reduced-capability terminal, and then receives a BWP configuration and a CORESET configuration, wherein the BWP configuration has 15 RBs, the CORESET configuration indicates three RB groups by frequencyDomainResources, and RB group 2 is an RB group that is not fully contained in the BWP, the first three RBs of the RB group are within the BWP bandwidth and the duration configuration is 2 at this time, so the terminal determines that CORESET frequency domain resources has 15 RBs, and the CORESET contains five CCEs. In another embodiment, in the above scenario, the duration can also be configured as 6. When the duration is configured as 6, the interleaved REG bundle has a symbol number of 6. The CORESET with more symbols facilitates the enhancement of the performance of downlink control channel in small bandwidth scenarios. According to the CORESET configuration, the terminal performs the mapping of CCEs to REGs, and the mapping of PDCCH candidates to CCEs, and receives PDCCHs.

Sub-Method 2: The Terminal Receiving the CORESET Frequency Domain Indication with a Predefined Granularity

When the terminal is determined to be a reduced-capability terminal and/or the bandwidth of the cell where it is located is a predefined value, the terminal determines the frequency domain resources of CORESET indicated by frequencyDomainResources according to the predefined RB granularity, wherein the predefined RB granularity is a positive integer less than 6. Otherwise, the terminal determines the frequency domain resources of CORESET according to the indication of frequencyDomainResources, wherein the granularity of RB group is 6. The method can improve the frequency band efficiency, and is simple to be realized by the terminal.

To meet the requirements of CCE-to-REG mapping, the resource block REG composed of time domain and frequency domain of the CORESET should be a multiple of 6. Therefore, with the RB number indicated by frequency DomainResources with a predefined RB granularity, the duration value must be such that the product of the value of RB number and the duration is a multiple of 6, and the duration's value can be 1 or 2 or 3 or 6. In this case, when the duration is 6 and interleaving is configured, the size of a REG bundle is 6.

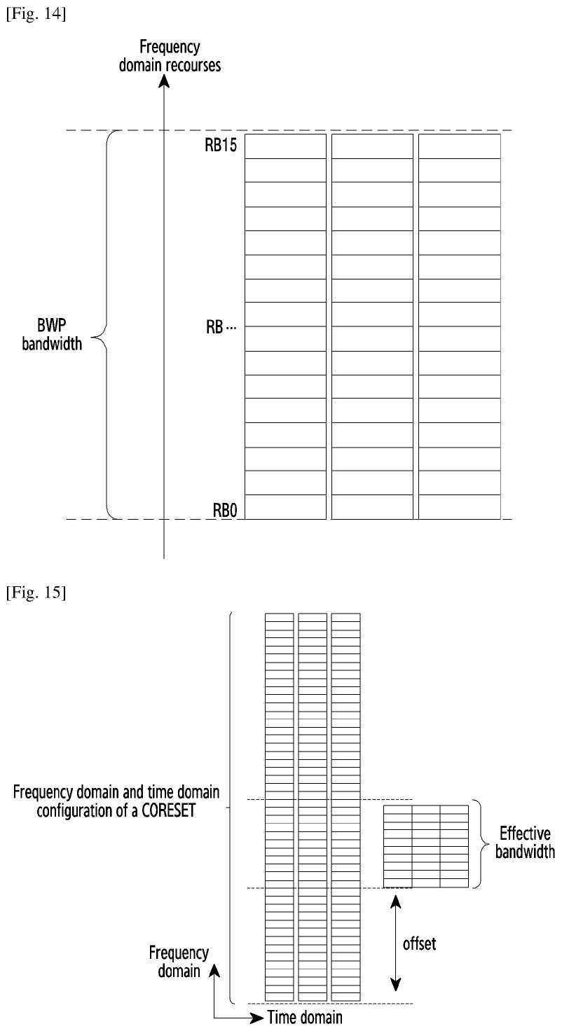

In one embodiment, the terminal first determines whether the bandwidth of the cell where it is located is 3 MHz or the terminal is a reduced-capability terminal, when the condition is met, the terminal receives the frequency domain resources frequencyDomainResources of CORESET, and performs mapping for the indicated bits according to the RB granularity of 1. For example, {1111 1111 1111 1111 0000 000 . . . } indicates a configuration with 16 RBs in frequency domain, while the configuration duration is 3, as shown in FIG. 14. In another embodiment, in the above scenario, the duration can also be configured as 6. According to the CORESET configuration, the terminal performs the mapping of CCEs to REGs, and the mapping of PDCCH candidates to CCEs, and receives PDCCHs.

Method 2: The reduced-capability terminal receives the frequency domain configuration of the CORESET which exceeds the bandwidth capability of the terminal.

The bandwidth configured in BWP configuration for the existing reduced-capability terminal should not exceed its maximum supported bandwidth capability, a reduced-capability terminal with a maximum channel bandwidth of 5 MHz is introduced, and its radio frequency capability can be greater than 5 MHz. By restricting baseband scheduling, the channel and signal reception and transmission can be within the effective bandwidth of the terminal. The terminal with maximum 5 MHz bandwidth reduced-capability can be configured with the same BWP as that for the existing reduced-capability terminal, as a BWP may be configured with at most three CORESETs, the reduced-capability terminal which supports a maximum bandwidth of 5 MHz can be configured with the same CORESET as that for the existing reduced-capability terminal, which may reduce the impact on the existing reduced-capability terminal.

Sub-Method 1: The Terminal Receiving the Frequency Domain Configuration of the CORESET and Determines the Frequency Domain Area where the CORESET is Located

For the scenario where two types of reduced-capability terminals (i.e. the afore-mentioned reduced-capability terminal supporting a maximum bandwidth of 20 MHz and the reduced-capability terminal supporting a maximum bandwidth of 5 MHz) are configured with the same CORESET, when the frequency domain configuration indication of CORESET received by the reduced-capability terminal is larger than the maximum channel bandwidth supported by the terminal, the terminal can determine the effective frequency domain configuration of the CORESET by a predefined method, wherein the predefined method includes the terminal determining the effective bandwidth position in the configured CORESET frequency domain according to the indication. At first, the terminal determines that it is a reduced-capability terminal with a maximum channel bandwidth of 5 MHz, and the received frequency domain configuration of the CORESET exceeds its bandwidth capability, then, according to the frequency domain configuration parameter frequency DomainResources, the terminal takes the RB with an offset spacing from the first RB in the minimum RB group with a bit indicated by this parameter being 1 as the RB starting point of CORESET of the terminal, and the bandwidth occupied by a predefined number of RBs is the effective bandwidth of CORESET, as shown in FIG. 15.

In one embodiment, the offset may be indicated by Radio Resource Control (RRC) and/or media access control control element (MAC CE) and/or Downlink Control Information (DCI) signaling, and the bandwidth occupied by a predefined number of RBs is the channel bandwidth supported by the terminal. According to the received CORESET configuration, the terminal performs the mapping of CCEs to REGs, and the mapping of PDCCH candidates to CCEs, and receives PDCCH candidates within the effective RB range.

In one embodiment, the offset is determined by the mapping of PDCCH candidates to CCEs and the frequency domain positions of CCEs. the terminal determines CCE numbers included in PDCCH candidates according to the predefined method, because the bandwidth of reduced-capability terminals is limited, when blind detection is performed on CORESET which is larger than the channel bandwidth, the starting point of the frequency domain position of PDCCH candidates is taken as the starting point of CORESET, so that more PDCCH candidates can be detected in the frequency domain to a greater extent, thus enhancing the receiving performance of PDCCH.

For the search space set s, CORESET p, and slot n″, the mapping of existing PDCCH candidates to CCEs is determined by the following formula:

$$L \cdot \{ ( {Y}_{p , {n}_{s , f}^{{}_{μ}}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

In which N is the number of CCEs, M is the number of PDCCH candidates, L is the aggregation level, n_{CI} is the carrier indication, and m is the index of PDCCH candidate. For Common Search Space (CSS), Y_{p,n}_{_{s, f}}_{^{μ}}=0; for UE-specific search space (USS), Y_{p,n}_{_{s, f}}_{^{μ}}=(Aₚ·Y_{p, n}_{_{s, f}}_{^{μ}}−1) modD, Yₚ₋₁=n_{RNTI}≠0, n_{RNTI} is C-RNTI value. When pmod3=0, Aₚ=39827; when pmod3=1, Aₚ=39839; when pmod3=2, Aₚ=65537; D=65537; i=0, . . . , L−1;

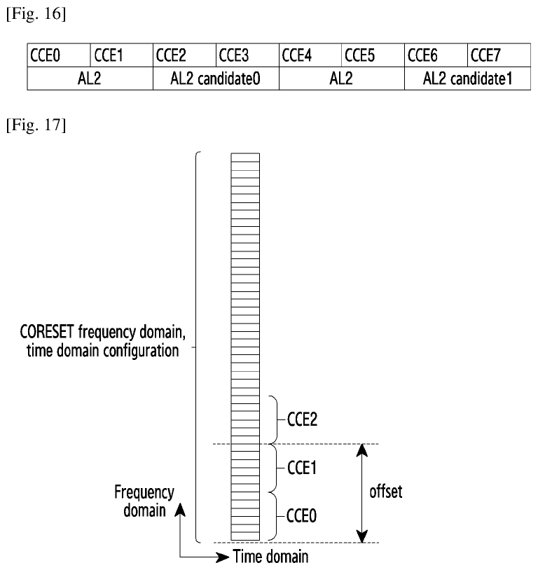

The RB indicated by the offset is the first RB in the first CCE of the m-th PDCCH candidate with an aggregation level (AL) of L. Where L and/or m are predefined non-negative integer values. For example, L is 2, m is 1, and the terminal detects CCE with an aggregation level AL of 2 in the first PDCCH candidate of the UE-specific search space (USS), as shown in FIG. 16.

When CORESET is configured to be non-interleaved, the first RB in the CCE2, that is, the starting position of RB, is shown in FIG. 17.

### Sub-Method 2: The Terminal Receiving the Non-Interleaved CORESET Configuration

First, the terminal determines whether it is a reduced-capability terminal and the radio frequency bandwidth is a predefined value, or the bandwidth of the cell where the terminal is located is a predefined value; if the bandwidth of the CORESET received by the terminal exceeds the radio frequency capability of the reduced-capability terminal or the cell bandwidth, the terminal determines that the used CORESET is non-interleaved and/or the CORESET is configured to be non-interleaved.

When the CCE-to-REG mapping is interleaved, the REG bundle in the CCE are distributed in the CORESET bandwidth at a certain spacing according to a predefined method. For the scenario in which the above two types of reduced-capability terminals are configured with the same CORESET, the bandwidth of CORESET may exceed the bandwidth 5 MHz supported by reduced-capability terminals. Due to the limited radio frequency bandwidth capability of the terminals, non-interleaving may cause the REGs occupied by PDCCH candidates concentrate within the terminal capability bandwidth. In one embodiment, the terminal is a reduced-capability terminal with a radio frequency bandwidth capability of 5 MHz; if the bandwidth of the received CORESET exceeds the radio frequency bandwidth capability of the terminal, the terminal does not expect to receive the interleaved CORESET, and the CORESET should be configured to be non-interleaved. In one embodiment, CORESET can be CORESET0.

In one embodiment, in the future railway mobile communication system a cell bandwidth of 3 MHz to 5 MHz will be introduced, if the existing CORESET0 frequency domain configuration exceeds the cell bandwidth, the terminal will receive the CORESET0 within the cell bandwidth in a predefined method. Since the existing CORESET0 is defaulted to be in the interleaved mode and the size of a REG bundle group is 6, CCEs belonging to the same PDCCH candidate are distributed in CORESET0 at certain spacing at this time. Due to the limited receiving bandwidth capability of the system bandwidth, the number of PDCCH CCEs that can be detected decreases due to interleaving. Therefore, an indication about whether CORESET0 is interleaved can be introduced into PBCH, and when the indication is a specific value, CORESET0 will no longer be interleaved. In one embodiment, a reserved bit(s) in the PBCH payload may be used for indication.

Sub-Method 3: The Terminal Receiving a PDCCH Candidate with a Smaller Aggregation Level

The terminal determines whether the cell bandwidth where it is located is a predefined frequency range and/or terminal type and/or whether it supports the newly introduced cell bandwidth, and determines the aggregation level type of Type0/0A/2-PDCCH Common Search Space (CSS). The method can ensure that the PDCCH candidate is within the bandwidth range when the bandwidth is small, and thus is beneficial to reception. Specifically, the terminal first determines whether the bandwidth of the cell where it is located is a predefined frequency range and/or whether the terminal itself is a reduced-capability terminal, when the conditions are met, the terminal defaults that the aggregation level(s) of Type0/0A/2-PDCCH CSS is 1 or 2 or 4 or 8 or 16, and the number of corresponding PDCCH candidates is shown in Table 1 below.

TABLE 1
CCE aggregation levels of CSS set configured by
searchSpaceSIB1 and the maximum number of PDCCH
candidates for each CCE aggregation level

| CCE Aggregation Level | Number of Candidates |
|---|---|
| 1 | 16 |
| 2 | 8 |
| 4 | 4 |
| 8 | 2 |
| 16 | 1 |

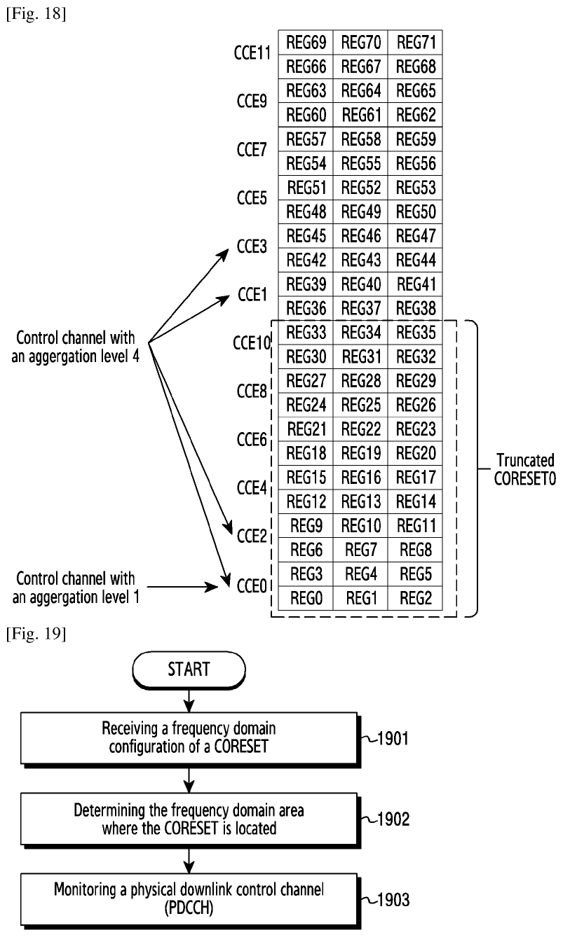

In one embodiment, the subcarrier spacing of CORESET0 is 30 KHz, the number of RBs is 24, the number of symbols is 3, and the bandwidth supported by the reduced-capability terminal is 5 MHz. When CORESET0 is received, the configured CORESET0 is truncated, not all CCEs occupied by the PDCCH candidates with an aggregation level of 4 in the effective CORESET0 are in the truncated CORESET0. At this time, the terminal can receive PDCCH candidates according to a smaller aggregation level, for example, the aggregation level of 1, as shown in FIG. 18.

### Sub-Method 4: The Terminal Receiving Interleaving CORESET Configuration

In one embodiment, the determined CORESET0 is associated with the CCE (Control Resource Element)—to REG (Resource Element Group) mapping, and the CCE to REG mapping is interleaving. Within the frequency domain range of CORESET0 determined by the terminal equipment, the terminal equipment determines the aggregation level within the frequency domain range of CORESET0 according to the mapping from CCE to REG. The terminal device receives one or more PDCCH for physical downlink shared channel (PDSCH) indication(s) in the SIB1 message(s) according to the determined aggregation level.

### For CCE to REG Mapping:

Wherein, the determined CORESET0 includes multiple REG bundles, the ith REG bundle includes the {iL, iL+1, iL+L−1}th REG, L is the number of REGs included in a REG bundle, and the range of i is 0,1, . . . , N_{REG}^{CORESET}/L−1, NCORESET is the product of N_{RB}^{CORESET} and N_{symb}^{CORESET}, that is, the number of REGs (that is, the number of RBs) within the determined time-frequency resource range of CORESET0, N_{RB}^{CORESET} is the number of RBs included in the determined CORESET0, N_{symb}^{CORESET} is the time domain symbol included in the determined CORESET0. Wherein, the determined CORESET0 can be determined according to the methods described elsewhere in the disclosure or other known methods. Wherein, the determined CORESET0 can be a complete CORESET0, or the determined CORESET0 can be a truncated CORESET0, or the determined CORESET0 can also be a part of a complete CORESET0. When N_{RB}^{CORESET} is 15, the value of L can be 3, 5 or 6. When N_{RB}^{CORESET} is 16, the value of L can be 2, 4, 6 or 8 (that is, the value of L can be different depending on different N_{symb}^{CORESET} values). symb
The jth CCE included in the determined CORESET0 includes the {f (Xj/L), f (Xj/L+1), . . . , f (Xj/L+X/L−1)}th REG bundles. The value of X can be specified in the protocol, notified by the network equipment through high-level signaling, predefined by the system, or equal to the value of L.

Among them,

$$f ( x ) = ( r C + c + {n}_{shift} ) mod ( {N}_{R E G}^{C O R E S E T} / L ) \\ wherein , \\ x = c R + r \\ r = 0 , 1 , … , R - 1 \\ c = 0 , 1 , … , C - 1 \\ C = {N}_{R E G}^{C O R E S E T} / ( LR )$$

Where R is the predefined parameter of the system. When N_{RB}^{CORESET} is 15, the value of R can be 2, 3, 4, 5 or 8. When N_{RB}^{CORESET} is 16, the value of R can be 2 or 4.

n_{shift} refers to the ID of the cell after the terminal equipment accesses, or the ID of the cell receiving downlink control channel/data channel.

Optionally, when N_{REG}^{CORESET}/(LR) is not an integer, that is, C is not an integer, C is rounded up, that is, the value of C is the smallest integer greater than itself.

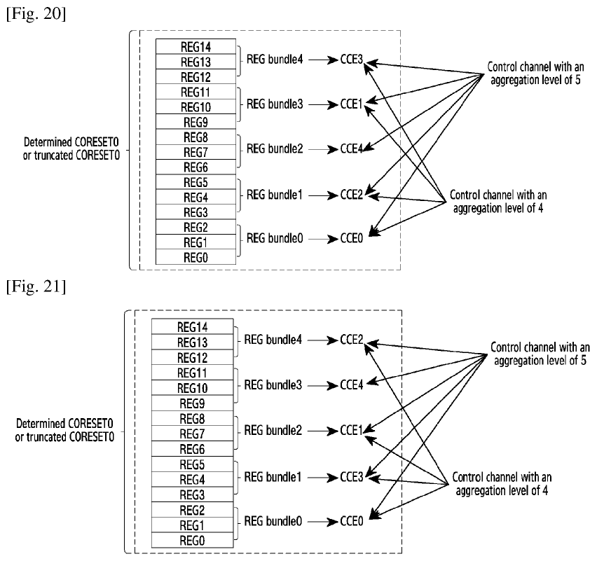

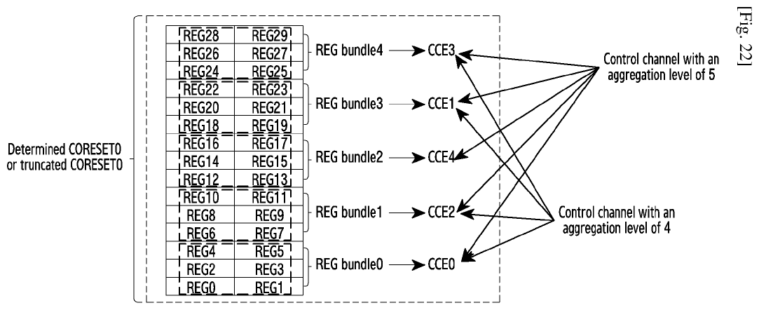

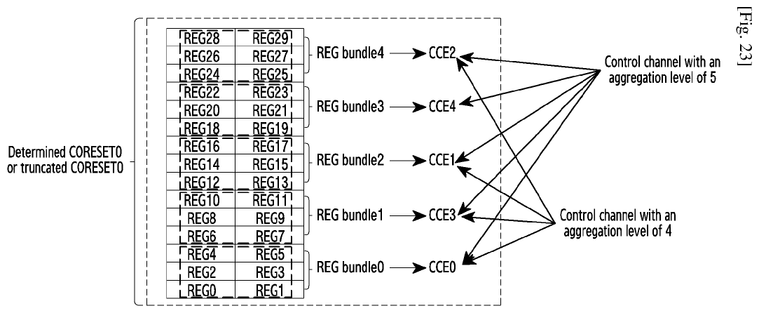

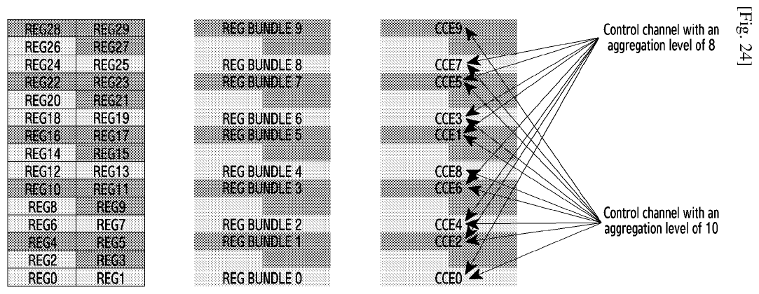

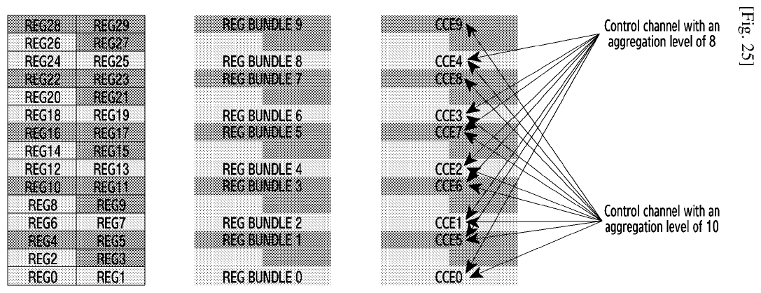

In one example, when N_{symb}^{CORESET} equals 1, and N_{RG}^{CORESET} equals 15, L equals 3 and R equals 2, or L equals 3 and R equals 3. The value of X above is 3. Take n_{shift} equaling 0 as an example, as shown in FIG. 20 and FIG. 21:

In FIG. 20, N_{symRG}^{CORESET}/(LR) is equal to 2.5, and C is rounded up to 3. In FIG. 21, when N_{REG}^{CORESET}/(LR) is about 1.67, then C is rounded up to 2. One REG bundle includes three REGs, and one CCE includes three REGs. In the determined CORESET0, the control channel monitoring of an aggregation level of 4 or 5 can be supported at most. The terminal device performs PDCCH demodulation in the CCE shown in FIG. 20 or FIG. 21. By determining the CCE in the CORESET0 in this way, the PDCCH demodulation performance of terminal equipment in the determined CORESET0 can be guaranteed.

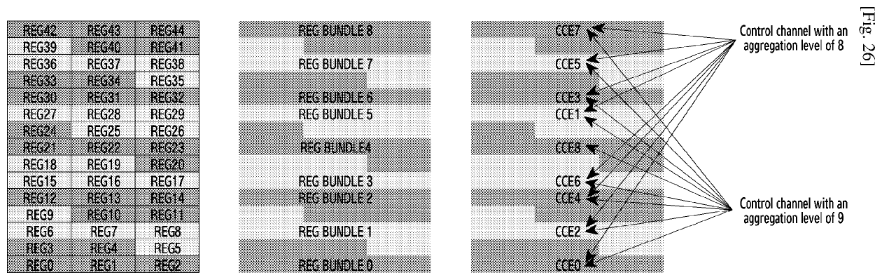

In one example, when N_{symb}^{CORESET} equals 2, and N_{RB}^{CORESET} equals 15, L equals 6 and R equals 2, or L equals 6 and R equals 3. The value of X above is 6. Take n_{shift} equaling 0 as an example, as shown in FIG. 22 and FIG. 23:

In FIG. 22, N_{REG}^{CORESET}/(LR) is equal to 2.5, and C is rounded up to 3. In FIG. 23, when N_{REG}^{CORESET}/(LR) is about 1.7, then C is rounded up to 2. One REG bundle includes six REGs, and one CCE includes six REGs. In the determined CORESET0 or truncated CORESET0, the control channel monitoring of an aggregation level of 4 or 5 can be supported at most. The terminal device performs PDCCH demodulation in the CCE shown in FIG. 22 or FIG. 23. By determining the CCE in CORESET0 in this way, the PDCCH demodulation performance of terminal equipment in the truncated or determined CORESET0 can be guaranteed.

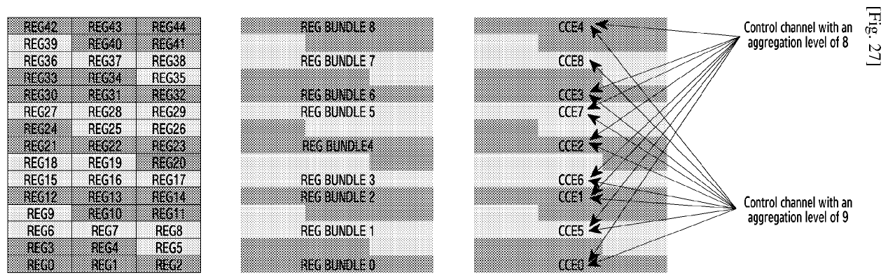

In another example, when N_{REG}^{CORESET}/(LR) equals 2, and N_{RB}^{CORESET} equals 15, L equals 3 and R equals 2, or L equals 3 and R equals 5. The value of X above is 3. Take n_{shift} equaling 0 as an example, as shown in FIG. 24 and FIG. 25:

In FIG. 24, N_{REG}^{CORESET}/(LR) is equal to 5. In FIG. 25, N_{REG}^{CORESET}/(LR) is equal to 2. One REG bundle includes three REGs, and one CCE includes three REGs. In the determined CORESET0 or truncated CORESET0, the control channel monitoring of an aggregation level of 8 or 10 can be supported at most. The terminal device performs PDCCH demodulation in the CCE shown in FIG. 24 or FIG. 25. By determining CCE in CORESET0 in this way, the PDCCH demodulation performance of the terminal equipment in the truncated or determined CORESET0 can be guaranteed.

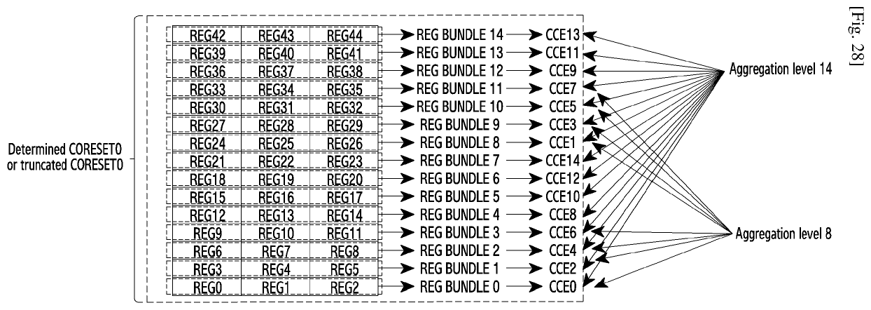

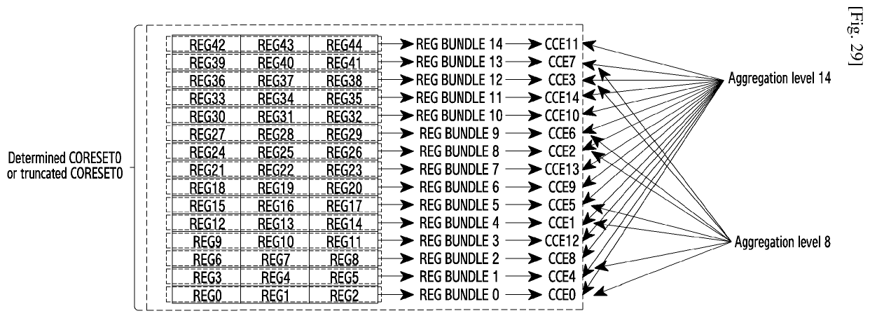

In one example, when symb N_{symb}^{CORESET} equals 3, and N_{RB}^{CORESET} equals 15, L equals 5 and R equals 2, or L equals 5 and R equals 5. The value of X above is 5. Take n_{shift} equaling 0 as an example, as shown in FIG. 26 and FIG. 27:

In FIG. 26, N_{REG}^{CORESET}/(LR) is equal to 4.5, and C is rounded up to 5. In FIG. 27, when N_{REG}^{CORESET}/(LR) is equal to 1.8, then C is rounded up to 2. One REG bundle includes five REGs, and one CCE includes five REGs. In the determined CORESET0 or truncated CORESET0, monitoring of the control channel at an aggregation level of 8 or 9 can be supported at most. The terminal device performs PDCCH demodulation in the CCE shown in FIG. 26 or FIG. 27. By determining CCE in CORESET0 in this way, the PDCCH demodulation performance of terminal equipment in the truncated or determined CORESET0 can be guaranteed.

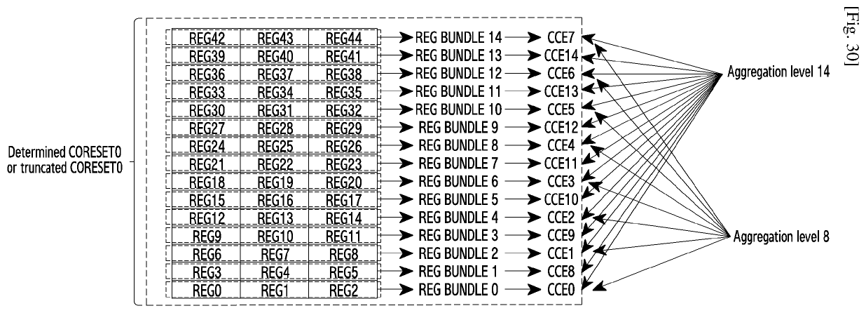

In one example, when N_{symb}^{CORESET} equals 3, and N_{RB}^{CORESET} equals 15, L equals 3 and R Vsymb equals 2, or L equals 3 and R equals 4, or L equals 3 and R equals 8. The value of X above is 3. Take n_{shift} equaling 0 as an example, as shown in FIG. 28 and FIG. 29:

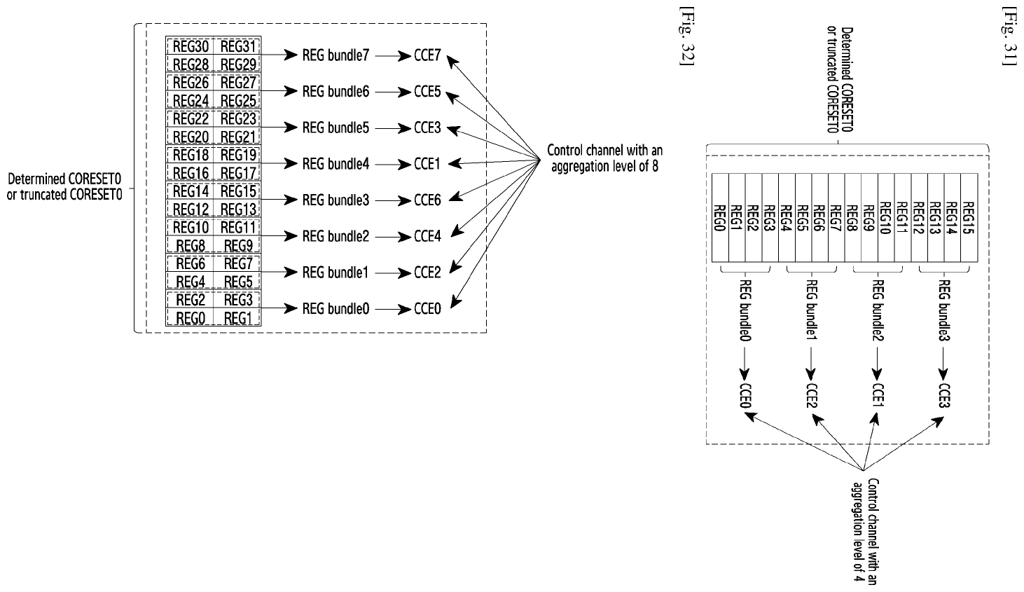

In FIG. 28, at this time, N_{REG}^{CORESET}/(LR) is equal to 7.5, and C is rounded up to 8. In FIG. 29, when N_{REG}^{CORESET}/(LR) is equal to 3.75, then C is rounded up to 4. In FIG. 30, N_{REG}^{CORESET}/(LR) is equal to 1.875, then C is rounded up to 2. At this time, REG one REG bundle includes three REGs, and one CCE includes three REGs. In the determined CORESET0 or truncated CORESET0, monitoring of the control channel at an aggregation level of 14 or 8 can be supported at most. The terminal device performs PDCCH demodulation in the CCE shown in FIG. 28, FIG. 29, or FIG. 30. By determining CCE in CORESET0 in this way, the PDCCH demodulation performance of the terminal equipment in the truncated or determined CORESET0 can be guaranteed.

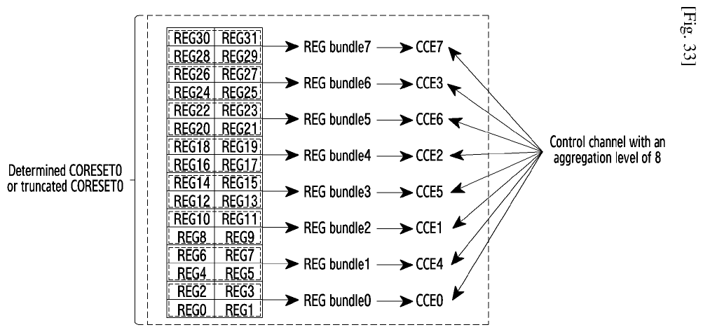

In one example, when N_{symb}^{CORESET} equals 1, and N_{RB}^{CORESET} equals 16, L equals 4, R equals 2, and the value of X above is 4. Take n_{shift} equaling 0 as an example, as shown in FIG. 31. At this time, one REG bundle includes four REGs, and one CCE includes four REGs. In the determined CORESET0 or truncated CORESET0, monitoring of the control channel at an aggregation level of 4 can be supported at most. The terminal device performs PDCCH demodulation in the CCE shown in the figure. By determining CCE in CORESET0 in this way, the PDCCH demodulation performance of the terminal equipment in the truncated or determined CORESET0 can be guaranteed.

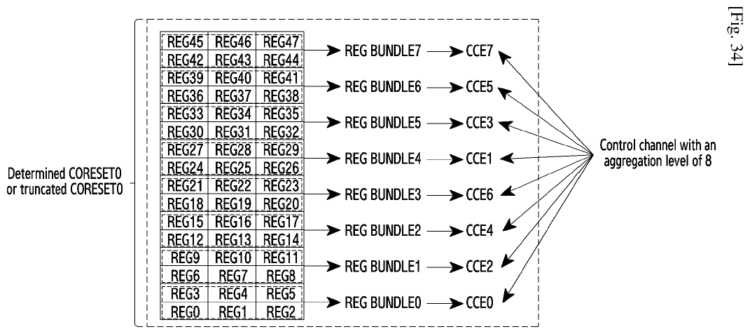

In another example, when N_{symb}^{CORESET} equals 2, and N_{RB}^{CORESET} is equal to 16, the value symb of X above is 4. Take n_{shift} equaling 0 as an example the following two values taken by R and L is described. As shown in FIG. 32, L equals 4 and R equals 2; Or, as shown in FIG. 33, L equals 4 and R equals 4. At this time, one REG bundle includes four REGs, and one CCE includes four REGs. In the determined CORESET0 or truncated CORESET0, monitoring of the control channel at an aggregation level of 8 can be supported at most. The terminal device performs PDCCH demodulation in the CCE shown in FIG. 32 or FIG. 33. By determining CCE in CORESET0 in this way, the PDCCH demodulation performance of the terminal equipment in the truncated or determined CORESET0 can be guaranteed.

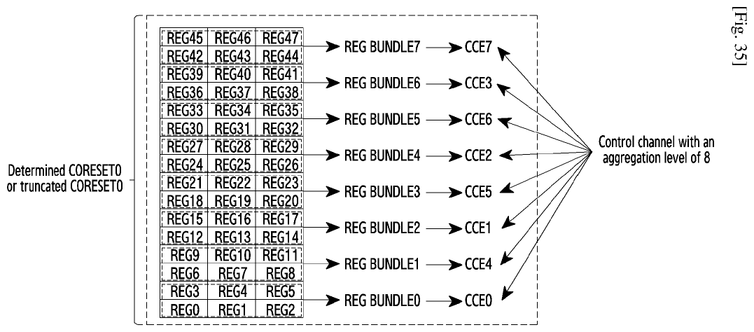

In another example, when N_{symb}^{CORESET} equals 3, and N_{RB}^{CORESET} is equal to 16, the value of X above is 6. Take n_{shift} equaling 0 as an example the following two values taken by R and L are described. As shown in FIG. 34, L equals 6 and R equals 2; Or, as shown in FIG. 35, L equals 6 and R equals 4. At this time, one REG bundle includes four REGs, and one CCE includes four REGs. In the determined CORESET0 or truncated CORESET0, monitoring of the control channel at an aggregation level of 8 can be supported at most. The terminal device performs PDCCH demodulation in the CCE shown in FIG. 34 or FIG. 35. By determining CCE in CORESET0 in this way, the PDCCH demodulation performance of terminal equipment in truncated or determined CORESET0 can be guaranteed.

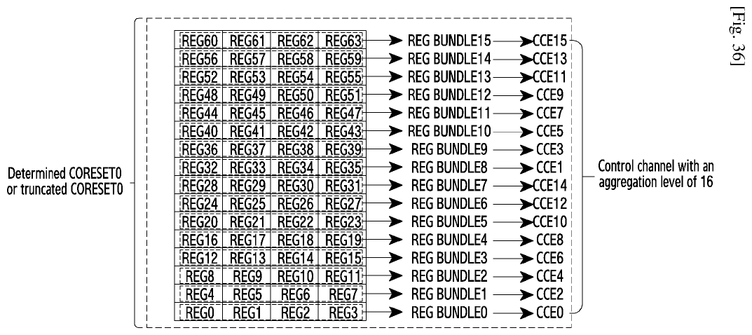

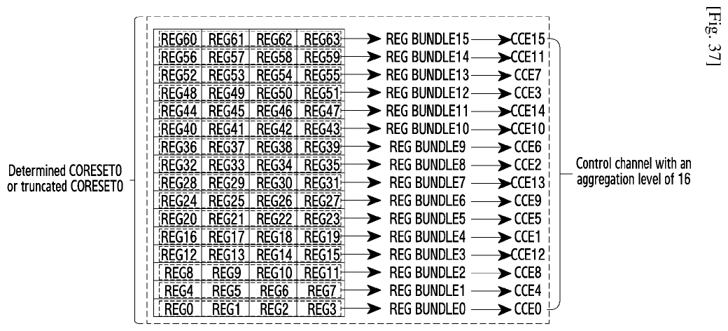

Optional, when N_{symb}^{CORESET} equals 4, and N_{RB}^{CORESET} is equal to 16, the value of X is 4, VRB symb Take n_{shift} equaling 0 as an example to describe the following two values of R and L. As shown in FIG. 36, L equals 4 and R equals 2; Or, as shown in FIG. 37, L equals 4 and R equals 4. At this time, one REG bundle includes four REGs, and one CCE includes four REGs. In the determined CORESET0 or truncated CORESET0, monitoring of the control channel at an aggregation level of 16 can be supported at most. The terminal device performs PDCCH demodulation in the CCE shown in FIG. 36 or FIG. 37. By determining CCE in CORESET0 in this way, the PDCCH demodulation performance of terminal equipment in truncated or determined CORESET0 can be guaranteed.

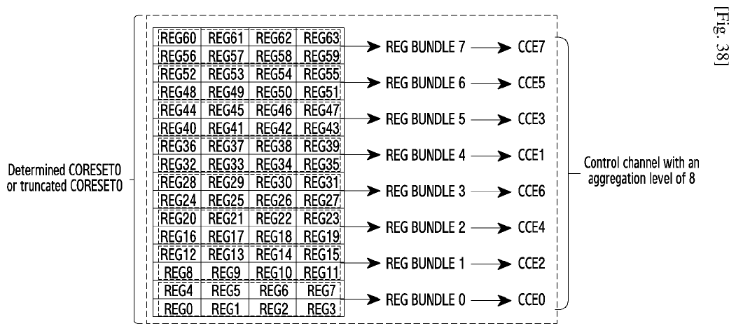

Optional, when N_{symb}^{CORESET} equals 4, and N_{RB}^{CORESET} is equal to 16, the value of X is 8, Take n_{shift} equaling 0 as an example, the following two values of R and L are described. As shown in FIG. 38, L equals 8 and R equals 2; Or, as shown in FIG. 39, L equals 8 and R equals 4. At this time, one REG bundle includes eight REGs, and one CCE includes eight REGs. In the determined CORESET0 or truncated CORESET0, monitoring of the control channel at an aggregation level of 8 can be supported at most. The terminal device performs PDCCH demodulation in the CCE shown in FIG. 38 or FIG. 39. By determining the CCE in the CORESET0 in this way, the PDCCH demodulation performance of the terminal equipment in the truncated or determined CORESET0 can be guaranteed.

When the minimum channel bandwidth supported by the frequency band where the terminal device cell is located is less than 5 MHz or the minimum bandwidth capability supported by the terminal device is less than 5 MHz, the terminal device can determine the time-frequency location of CORESET0 according to the method of the present disclosure, so that the frequency domain resources of CORESET0 are included in the radio frequency capability range of the terminal device. In addition, according to the method of this disclosure, the mapping mode of logical resource CCE to physical resource REG in CORESET0 can be determined to obtain more aggregation levels and improve the blind detection performance of PDCCH.

FIG. 19 shows a schematic diagram of a method, according to an embodiment of the present disclosure.

In step 1901, the terminal receives the control resource set (CORESET).

In step 1902, the terminal determines the frequency domain area where the CORESET is located, wherein the frequency domain area where the CORESET is located includes at least a part of the frequency domain area of CORESET determined based on the received frequency domain configuration of the CORESET.

In step 1903, the terminal monitors a downlink control channel PDCCH based on the determined frequency domain area where the CORESET is located.

In one embodiment, the frequency domain configuration of the CORESET includes one or more resource block (RB) groups, wherein at least one RB in one RB group of the one or more RB groups is within the BWP bandwidth.

In various embodiments, the method further comprising receiving a time domain duration of the CORESET corresponding to the frequency domain configuration of the CORESET, wherein, when the number of RBs in the BWP bandwidth of the one RB group in the frequency domain configuration of the CORESET is 1, the time domain duration is 6; and/or when the number of RBs in the BWP bandwidth of the one RB group in frequency domain configuration of the CORESET is 2, the time domain duration is 3 or 6; and/or when the number of RBs in the BWP bandwidth of the one RB group in frequency domain configuration of the CORESET is 3, the time domain duration is 2 or 6; and/or when the number of RBs in the BWP bandwidth of the one RB group in the frequency domain configuration of the CORESET is 4 or 5, the time domain duration is 6.

In one embodiment, the number of RBs included in the resource block (RB) group is a predefined value.

In one embodiment, the predefined value is a positive integer less than 6.

In one embodiment, the method further comprises receiving the time domain duration of CORESET corresponding to the frequency domain configuration of the CORESET, wherein the product of the time domain duration and the number of RBs occupied by all RB groups in the frequency domain configuration of the CORESET is a multiple of 6.

In one embodiment, the method further comprises receiving a time domain duration of the CORESET, interleaving configuration and resource element group (REG) bundle configuration corresponding to the frequency domain configuration of the CORESET, wherein when the time domain duration is 6 and the interleaving configuration is interleaving, the resource element group (REG) bundle size is 6.

In one embodiment, at least a part of the frequency domain area of CORESET determined based on the frequency domain configuration of the CORESET comprises the bandwidth occupied by a predefined number of RBs starting from a specific RB in a specific RB group within the frequency domain area indicated by the frequency domain configuration of the CORESET.

In one embodiment, the starting point of the frequency domain area of the CORESET is determined by a specific RB in the specific RB group, and wherein the specific RB is an RB with an offset spacing from the first RB in the RB group with the smallest index indicated by the bit being 1 indicated by the frequencyDomainResources configuration parameter.

In one embodiment, the bandwidth occupied by the predefined number of RBs is less than or equal to the channel bandwidth supported by the terminal.

In one embodiment, the offset is indicated by RRC signaling and/or media access control control element (MAC CE) and/or downlink control information (DCI) signaling; and/or wherein the offset is determined by mapping PDCCH candidates to CCEs and the frequency domain positions of CCEs.

In one embodiment, the method further comprises: monitoring a physical downlink control channel (PDCCH) based on non-interleaved CORESET; and/or wherein the interleaving configuration corresponding to the received frequency domain configuration of the CORESET is non-interleaving.

In one embodiment, the interleaving configuration is used to indicate whether CORESET is interleaved, wherein the interleaving configuration is indicated by a specific field in the physical broadcast channel (PBCH).

In one embodiment, the specific field is a reserved bit in the payload, and wherein the CORESET is CORESET0.

In one embodiment, the aggregation level(s) of the Type0/0A/2-PDCCH common search space (CSS) corresponding to the received frequency domain configuration of the CORESET is 1 or 2 or 4 or 8 or 16.

According to another aspect of the present disclosure, there is provided a terminal in a wireless communication system, which includes a transceiver configured to transmit and receive signals; and a processor coupled to the transceiver and configured to control the transceiver to perform the methods described in the above embodiments.

According to another aspect of the present disclosure, there is provided a method performed by a base station in a wireless communication system, which includes transmitting a frequency domain configuration of a CORESET to a terminal, and transmitting a physical downlink control channel (PDCCH) to the terminal, wherein the frequency domain area where the PDCCH is located is at least a part of the frequency domain area determined by the frequency domain configuration of the CORESET.

In one embodiment, the frequency domain configuration of the CORESET includes one or more resource block (RB) groups, wherein a part of RBs in one RB group of the one or more RB groups is within the BWP bandwidth.

In one embodiment, the method further comprises: transmitting a time domain duration of the CORESET corresponding to the frequency domain configuration of the CORESET to the terminal, wherein when the number of RBs in the BWP bandwidth of one RB group in the frequency domain configuration of the CORESET is 1, the time domain duration is 6; and/or when the number of RBs in the BWP bandwidth of one RB group in the frequency domain configuration of the CORESET is 2, the time domain duration is 3 or 6; and/or when the number of RBs in the BWP bandwidth of one RB group in the frequency domain configuration of the CORESET is 3, the time domain duration is 2 or 6; and/or when the number of RBs in the BWP bandwidth of one RB group in the frequency domain configuration of the CORESET is 4 or 5, the time domain duration is 6.

In one embodiment, the number of RBs included in the resource block (RB) group is a predefined value.

In one embodiment, the predefined value is a positive integer less than 6.

In one embodiment, the method further comprises transmitting a time domain duration of CORESET corresponding to the frequency domain configuration of the CORESET, wherein the product of the time domain duration and the number of RBs occupied by all RB groups in the frequency domain configuration of the CORESET is a multiple of 6.

In one embodiment, the method further comprises transmitting a time domain duration of the CORESET, an interleaving configuration and a resource element group (REG) bundle configuration corresponding to the frequency domain configuration of the CORESET, wherein when the time domain duration is 6 and the interleaving configuration is interleaving, the resource element group (REG) bundle size is 6.

In one embodiment, at least a part of the frequency domain area where the PDCCH is located includes the bandwidth occupied by a predefined number of RBs starting from a specific RB in a specific RB group in the frequency domain area indicated by the frequency domain configuration of the CORESET.

In one embodiment, the starting point of the frequency domain area of the CORESET is determined by a specific RB in the specific RB group, and wherein the specific RB is an RB with an offset spacing from the first RB in the RB group with the smallest index indicated by the bit being 1 indicated by the frequencyDomainResources configuration parameter.

In one embodiment, the bandwidth occupied by the predefined number of RBs is less than or equal to the channel bandwidth supported by the terminal.

In one embodiment, the offset is indicated by RRC signaling and/or media access control control element (MAC CE) and/or downlink control information (DCI) signaling; and/or wherein the offset is determined by mapping PDCCH candidates to CCEs and the frequency domain positions of CCEs.

In one embodiment, the interleaving configuration corresponding to the transmitted frequency domain configuration of the CORESET is non-interleaved and/or the physical downlink control channel (PDCCH) is transmitted based on the non-interleaved CORESET.

In one embodiment, the interleaving configuration is used to indicate whether CORESET is interleaved, wherein the interleaving configuration is indicated by a specific field in the physical broadcast channel (PBCH).

In one embodiment, the specific field is a reserved bit in the payload, and wherein the CORESET is CORESET0.

In one embodiment, the aggregation level(s) of the Type0/0A/2-PDCCH common search space (CSS) corresponding to the sent frequency domain configuration of the CORESET is 1 or 2 or 4 or 8 or 16.

According to another aspect of the present disclosure, there is provided a base station in a wireless communication system, including a transceiver configured to transmit and receive signals; and a processor coupled to the transceiver and configured to control the transceiver to perform the methods described in the above embodiments.

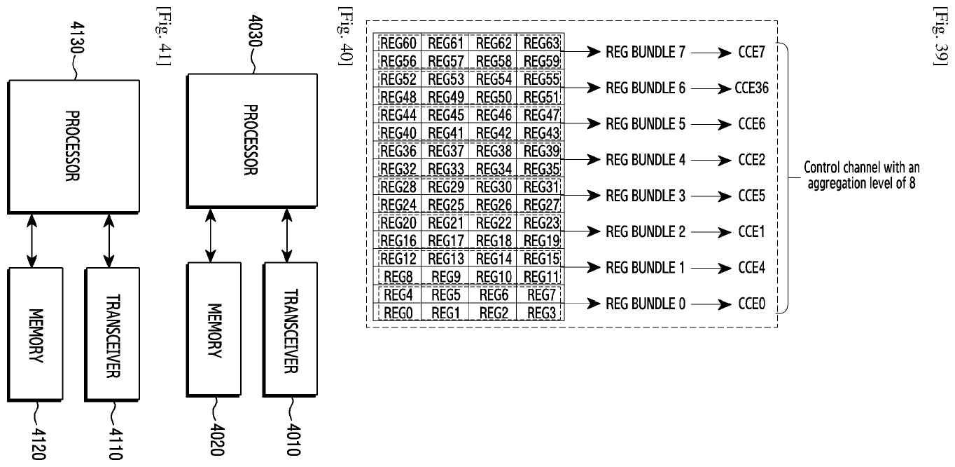

FIG. 40 is a block diagram of a configuration of a base station, according to an embodiment of the disclosure; and

Referring to FIG. 40, the base station according to an embodiment may include a transceiver 4010, a memory 4020, and a processor 4030. The transceiver 4010, the memory 4020, and the processor 4030 of the base station may operate according to a communication method of the base station described above. However, the components of the base station are not limited thereto. For example, the base station may include more or fewer components than those described above. In addition, the processor 4030, the transceiver 4010, and the memory 4020 may be implemented as a single chip. Also, the processor 4030 may include at least one processor.

The transceiver 4010 collectively refers to a base station receiver and a base station transmitter, and may transmit/receive a signal to/from a terminal. The signal transmitted or received to or from the terminal may include control information and data. The transceiver 4010 may include a RF transmitter for up-converting and amplifying a frequency of a transmitted signal, and a RF receiver for amplifying low-noise and down-converting a frequency of a received signal. However, this is only an example of the transceiver 4010 and components of the transceiver 4010 are not limited to the RF transmitter and the RF receiver.

Also, the transceiver 4010 may receive and output, to the processor 4030, a signal through a wireless channel, and transmit a signal output from the processor 4030 through the wireless channel.

The memory 4020 may store a program and data required for operations of the base station. Also, the memory 4020 may store control information or data included in a signal obtained by the base station. The memory 4020 may be a storage medium, such as read-only memory (ROM), random access memory (RAM), a hard disk, a CD-ROM, and a DVD, or a combination of storage media.

The processor 4030 may control a series of processes such that the base station operates as described above. For example, the transceiver 4010 may receive a data signal including a control signal transmitted by the terminal, and the processor 4030 may determine a result of receiving the control signal and the data signal transmitted by the terminal.

FIG. 41 is a block diagram showing a structure of a terminal, according to an embodiment of the disclosure.

Referring to FIG. 41, the terminal of the disclosure may include a transceiver 4110, a memory 4120, and a processor 4130. The transceiver 4110, the memory 4120, and the processor 4130 of the terminal may operate according to a communication method of the terminal described above. However, the components of the terminal are not limited thereto. For example, the terminal may include more or fewer components than those described above. In addition, the processor 4130, the transceiver 4110, and the memory 4120 may be implemented as a single chip. Also, the processor 4130 may include at least one processor.

The transceiver 4110 collectively refers to a terminal receiver and a terminal transmitter, and may transmit/receive a signal to/from a base station. The signal transmitted or received to or from the base station may include control information and data. In this regard, the transceiver 4110 may include a RF transmitter for up-converting and amplifying a frequency of a transmitted signal, and a RF receiver for amplifying low-noise and down-converting a frequency of a received signal. However, this is only an example of the transceiver 4110 and components of the transceiver 4110 are not limited to the RF transmitter and the RF receiver.

Also, the transceiver 4110 may receive and output, to the processor 4130, a signal through a wireless channel, and transmit a signal output from the processor 4130 through the wireless channel.

The memory 4120 may store a program and data required for operations of the terminal. Also, the memory 4120 may store control information or data included in a signal obtained by the terminal. The memory 4120 may be a storage medium, such as ROM, RAM, a hard disk, a CD-ROM, and a DVD, or a combination of storage media.

The processor 4130 may control a series of processes such that the terminal operates as described above. For example, the transceiver 4110 may receive a data signal including a control signal, and the processor 4130 may determine a result of receiving the data signal.

Those skilled in the art will understand that the above illustrative embodiments are described herein and are not intended to be limiting. It should be understood that any two or more of the embodiments disclosed herein can be combined in any combination. In addition, other embodiments can be utilized and other changes can be made without departing from the spirit and scope of the subject matter presented herein. It will be readily understood that aspects of the disclosed invention as generally described herein and shown in the drawings can be arranged, replaced, combined, separated and designed in various different configurations, all of which are con-templated herein.

Those skilled in the art will understand that various illustrative logical blocks, modules, circuits, and steps described in this application can be implemented as hardware, software, or combinations of both. To clearly illustrate this inter-changeability between hardware and software, various illustrative components, blocks, modules, circuits, and steps are generally described above in the form of their functional sets. Whether such a function set is implemented as hardware or software depends on the specific application and the design constraints imposed on the overall system. Those skilled in the art can implement the described set of functions in different ways for each specific application, but such design decisions should not be interpreted as causing a departure from the scope of this application.

The various illustrative logic blocks, modules, and circuits described in this application can be implemented with a general purpose processor, a Digital Signal Processor (DSP), an application specific integrated circuit (ASIC), a Field Programmable Gate Array (FPGA) or other programmable logic devices, discrete gate or transistor logic, discrete hardware components, or any combination thereof designed to perform the functions described herein. The general purpose processor may be a microprocessor, but in the alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in this application can be directly embodied in hardware, in a software module performed by a processor, or in a combination of the two. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

In one or more exemplary designs, the functions can be implemented in hardware, software, firmware, or any combination thereof. If implemented in software, each function can be stored on or transferred by a computer-readable medium as one or more instructions or codes. Computer readable media include both computer storage media and communication media, the latter including any media that facilitates the transfer of computer programs from one place to another. Storage media can be any available media that can be accessed by general purpose or special purpose computers.

The above description is only an exemplary embodiment of the present invention, and is not intended to limit the scope of claimed of the present invention, which is determined by the appended claims.

1. A method performed by a terminal in a wireless communication system, comprising:
receiving, a frequency domain configuration of a control resource set (CORESET),
determining a frequency domain area where the control resource set (CORESET) is located, wherein the frequency domain area where the CORESET is located comprises at least a part of the frequency domain area of the CORESET determined based on the received frequency domain configuration of the CORESET; and
monitoring a physical downlink control channel (PDCCH) based on the determined frequency domain area where the CORESET is located.

2. The method of claim 1, wherein the frequency domain configuration of the CORESET comprises:
one or more resource block (RB) groups,
wherein at least one RB in one RB group of the one or more RB groups is within the BWP bandwidth.

3. The method of claim 2, the method further comprising:
receiving a time domain duration of the CORESET corresponding to the frequency domain configuration of the CORESET,
wherein, when the number of RBs in the BWP bandwidth of the one RB group in frequency domain configuration of the CORESET is 1, the time domain duration is 6; and/or
when the number of RBs in the BWP bandwidth of the one RB group in frequency domain configuration of the CORESET is 2, the time domain duration is 3 or 6; and/or
when the number of RBs in the BWP bandwidth of the one RB group in frequency domain configuration of the CORESET is 3, the time domain duration is 2 or 6; and/or
when the number of RBs in the BWP bandwidth of the one RB group in the frequency domain configuration of the CORESET is 4 or 5, the duration of the time domain is 6.

4. The method of claim 2, wherein the number of RBs included in the RB group is a predefined value.

5. The method of claim 4, wherein the predefined value is a positive integer less than 6.

6. The method of claim 4, the method further comprising:
receiving a time domain duration of a CORESET corresponding to the frequency domain configuration of the CORESET,
wherein the product of the time domain duration and the number of RBs occupied by all RB groups in the frequency domain configuration of the CORESET is a multiple of 6.

7. The method of claim 2, the method further comprising:
receiving a time domain duration of the CORESET, interleaving configuration and resource element group (REG) bundle configuration corresponding to the frequency domain configuration of the CORESET,
wherein, when the time domain duration is 6 and the interleaving configuration is interleaving, the size of the resource element group (REG) bundle is 6.

8. The method of claim 1, wherein at least a part of the frequency domain area of CORESET determined based on the frequency domain configuration of the CORESET comprises:
the bandwidth occupied by a predefined number of RBs starting from a specific RB in a specific RB group within the frequency domain area indicated by the frequency domain configuration of the CORESET.

9. The method of claim 8, wherein a starting point of the frequency domain area of the CORESET is determined by a specific RB in the specific RB group, and
wherein, the specific RB is the RB with an offset spacing from a first RB in the RB group with the smallest index indicated by the bit being 1 indicated by the frequency domain resource configuration parameter frequency DomainResources.

10. The method of claim 8, wherein the bandwidth occupied by the predefined number of RBs is less than or equal to the channel bandwidth supported by the terminal.

11. The method of claim 9, wherein the offset is indicated by Radio Resource Control (RRC) signaling and/or media access control control element (MAC CE) and/or downlink control information (DCI) signaling; and/or
Wherein the offset is determined by the mapping of PDCCH candidates to CCEs and the frequency domain positions of CCEs.

12. The method of claim 8,
wherein the method further comprises: monitoring a physical downlink control channel (PDCCH) based on non-interleaved CORESET; and/or
wherein the interleaving configuration corresponding to the received frequency domain configuration of the CORESET is non-interleaving.

13. A terminal in a wireless communication system, comprising:
a transceiver configured to transmit and receive signals; and
a processor coupled to the transceiver and configured to:
receive, a frequency domain configuration of a control resource set (CORESET),
determine a frequency domain area where the control resource set (CORESET) is located, wherein the frequency domain area where the CORESET is located comprises at least a part of the frequency domain area of the CORESET determined based on the received frequency domain configuration of the CORESET; and
monitor a physical downlink control channel (PDCCH) based on the determined frequency domain area where the CORESET is located.

14. A method performed by a base station in a wireless communication system, comprising:
transmitting a frequency domain configuration of a control resource set (CORESET) to the terminal, and
transmitting a physical downlink control channel (PDCCH) to the terminal, wherein the frequency domain area where the PDCCH is located is at least a part of the frequency domain area determined by the frequency domain configuration of the CORESET.

15. A base station in a wireless communication system, comprising:
a transceiver configured to transmit and receive signals; and
a processor coupled to the transceiver and configured to:
transmit a frequency domain configuration of a control resource set (CORESET) to the terminal, and
transmit a physical downlink control channel (PDCCH) to the terminal,
wherein the frequency domain area where the PDCCH is located is at least a part of the frequency domain area determined by the frequency domain configuration of the CORESET.
